(19) United States
(12) Patent Application Publication
(10) Pub. No.: US 2024/0161472 A1
(43) Pub. Date: May 16, 2024

(54) METHOD, APPARATUS, DEVICE AND MEDIUM FOR PROCESSING IMAGE USING MACHINE LEARNING MODEL

(71) Applicant: Beijing Youzhuju Network Technology Co., Ltd., Beijing (CN)

(72) Inventors: Yi Jiang, Beijing (CN); Jiannan Wu, Beijing (CN); Bin Yan, Beijing (CN); Zehuan Yuan, Beijing (CN)

(21) Appl. No.: 18/499,066

(22) Filed: Oct. 31, 2023

(30) Foreign Application Priority Data
Nov. 4, 2022 (CN) 202211376746.3

(51) Int. Cl. G06V 10/774; G06T 7/73; G06V 10/22; G06V 10/764; G06V 10/77

(52) U.S. Cl. CPC G06V 10/7753; G06T 7/74; G06V 10/225; G06V 10/764; G06V 10/7715; G06T 2207/20081

(57) ABSTRACT

A method, device, and medium are provided for processing an image using a machine learning model that identifies at least one candidate object from an image. The model comprises: a feature extraction model for describing an association between the image and a feature of the at least one candidate object; and a classification scoring model for describing an association between the feature and a classification score of the at least one candidate object. An update parameter associated with the classification scoring model is determined based on the classification score of the at least one candidate object and a ground truth classification score of at least one ground truth object in the image. The classification scoring model is updated based on the update parameter associated with the classification scoring model. The feature extraction model is prevented from being updated with the update parameter associated with the classification scoring model.

### CROSS REFERENCE TO RELATED APPLICATIONS

The present application claims priority to Chinese Patent Application No. 202211376746.3, filed on Nov. 4, 2022 and entitled “METHODS, APPARATUSES, DEVICES AND MEDIA FOR PROCESSING AN IMAGE USING A MACHINE LEARNING MODEL”, the entirety of which is incorporated herein by reference.

### FIELD

Example implementations of the present disclosure relate generally to image processing, and more particularly to methods, apparatuses, devices, and computer-readable storage media for processing an image using a machine learning model.

### BACKGROUND

Machine learning technologies have been widely used in image processing. Currently, technical solutions used to identify objects in images based on the machine learning technologies have been proposed. For example, the objects can be labeled in the images in advance and machine learning models can be trained using the labeled images. However, the images used as training data may not comprise all objects in the real world, which leads to the fact that when the trained machine learning models are used to process an image to be processed, only objects that have been labeled in the training data can be identified from the image to be processed, and objects that have not been labeled in the training data cannot be identified. At this point, how to train machine learning models in a more effective way to improve identification accuracy has become a difficulty and a hot topic in the field of image processing.

### SUMMARY

In a first aspect of the present disclosure, a method for processing an image using a machine learning model is provided. The machine learning model herein is used for identifying at least one candidate object from an image, and the machine learning model comprises: a feature extraction model for describing an association between the image and a feature of the at least one candidate object; and a classification scoring model for describing an association between the feature of the at least one candidate object and a classification score of the at least one candidate object, the classification score representing a probability that the at least one candidate object is classified as foreground in the image. In this method, an update parameter associated with the classification scoring model is determined based on the classification score of the at least one candidate object and a ground truth classification score of at least one ground truth object in the image. The classification scoring model is updated based on the update parameter associated with the classification scoring model. The feature extraction model is prevented from being updated with the update parameter associated with the classification scoring model.

In a second aspect of the present disclosure, an apparatus for processing an image using a machine learning model is provided. The machine learning model herein is used for identifying at least one candidate object from an image, and the machine learning model comprises: a feature extraction model for describing an association between the image and a feature of the at least one candidate object; and a classification scoring model for describing an association between the feature of the at least one candidate object and a classification score of the at least one candidate object, the classification score representing a probability that the at least one candidate object is classified as foreground in the image. This apparatus comprises: a determination module configured for determining an update parameter associated with the classification scoring model based on the classification score of the at least one candidate object and a ground truth classification score of at least one ground truth object in the image; an update module configured for updating the classification scoring model based on the update parameter associated with the classification scoring model; and a prevention module configured for preventing the feature extraction model from being updated with the update parameter associated with the classification scoring model.

In a third aspect of the present disclosure, an electronic device is provided. This electronic device comprises at least one processing unit; and at least one memory coupled to the at least one processing unit and storing instructions for execution by the at least one processing unit which, when executed by the at least one processing unit, cause the electronic device to perform the method of the first aspect of the present disclosure.

In a fourth aspect of the present disclosure, a computer readable storage medium having a computer program stored thereon which, when executed by a processor, causes the processor to implement the method of the first aspect of the present disclosure.

It should be understood that the content described in this section is not intended to limit the essential features or important features of the implementation of the present disclosure, nor is it intended to limit the scope of the present disclosure. Other features of the present disclosure will be easily understood by the following description.

### BRIEF DESCRIPTION OF DRAWINGS

In the following, the above and other features, advantages, and aspects of implementations of the present disclosure will become more apparent in conjunction with the accompanying drawings and with reference to the following detailed descriptions. In the accompanying drawings, the same or similar reference numbers denote the same or similar elements, wherein:

FIG. 1 shows a block diagram of an image used as training data for a machine learning model in an implementation of the present disclosure;

FIG. 2 shows a block diagram of a structure of a machine learning model for identifying objects from images according to some implementations of the present disclosure;

FIG. 3 shows a block diagram of a process for determining an update parameter of a mask model according to some implementations of the present disclosure.

FIG. 4 shows a block diagram of a process for determining an update parameter of a bounding box model according to some implementations of the present disclosure.

FIG. 5 shows a block diagram of a process for determining an update parameter of a position scoring module according to some implementations of the present disclosure.

FIG. 6 shows a block diagram of a plurality of candidate objects in an image according to some implementations of the present disclosure.

FIG. 7 shows a block diagram of a process for selecting a positive and a negative sample from a plurality of candidate objects according to some implementations of the present disclosure.

FIG. 8 shows a block diagram of an object identified from an image to be processed using a machine learning model according to some implementations of the present disclosure;

FIG. 9 shows a flowchart of a method for processing an image using a machine learning model according to some implementations of the present disclosure;

FIG. 10 shows a block diagram of an apparatus for processing an image using a machine learning model according to some implementations of the present disclosure; and

FIG. 11 shows a block diagram of a device that can implement a plurality of implementations of the present disclosure.

### DETAILED DESCRIPTIONS

The following will describe implementations of the present disclosure in more detail with reference to the accompanying drawings. Although some implementations of the present disclosure are shown in the accompanying drawings, it should be understood that the present disclosure can be implemented in various forms and should not be construed as limited to the implementations set forth herein. On the contrary, these implementations are provided for a more thorough and complete understanding of the present disclosure. It should be understood that the drawings and implementations of the present disclosure are for illustrative purposes only and are not intended to limit the scope of the present disclosure.

In the description of the implementations of the present disclosure, the term “comprising” and similar terms should be understood to be openly inclusive, that is, “comprising but not limited to”. The term “based on” should be understood as “at least partially based on”. The terms “one implementation” or “the implementation” should be understood as “at least one implementation”. The term “some implementations” should be understood as “at least some implementations”. The following may also comprise other explicit and implicit definitions. As used herein, the term “model” can represent the correlation between various data. For example, the above correlation can be obtained based on various technical solutions currently known and/or to be developed in the future.

It can be understood that the data involved in this technical solution (comprising but not limited to the data itself, data acquisition or use) should comply with the requirements of corresponding laws, regulations and relevant provisions.

It will be appreciated that, before using the technical solutions disclosed in various embodiments of the present disclosure, users should be informed of the types, the scope of use, use scenarios and the like of personal information involved in the present disclosure in an appropriate manner according to relevant laws and regulations, and authorization should be obtained from the users.

For example, in response to receiving an active request from a user, a prompt message is sent to the user to explicitly prompt the user that the operation requested to be performed will require acquisition and use of the user's personal information. Thus, the user can autonomously select whether to provide the personal information to software or hardware such as electronic devices, applications, servers, or storage media that perform operations of the disclosed technical solution based on the prompt message.

As an optional but non-limiting implementation, in response to receiving the active request from the user, the manner to send the prompt message to the user can be pop-up windows, for example, in which the prompt message can be rendered in text. In addition, the pop-up windows can also carry selection controls for the user to select between “agree” or “disagree” to provide the personal information to electronic devices.

It can be understood that the above process for informing and obtaining the user's authorization are only illustrative and do not limit the implementations of the present disclosure. Other manners that comply with relevant laws and regulations can also be applied to the implementation of the present disclosure.

As used herein, the term “in response to” indicates a state in which a corresponding event occurs or a condition is satisfied. It will be understood that there may not be a strong correlation between performance occasion of a subsequent action performed in response to the event or condition and the time when the event occurs or the condition is satisfied. For example, in some cases, the subsequent action may be performed immediately when the event occurs or the condition is satisfied; and in other cases, the subsequent action may be performed after a period of time subsequent to the event occurring or the condition satisfied.

### Example Environment

In the context of the present disclosure, objects can represent entities with tangible shapes in images, such as but not limited to people, animals, objects, and so on. In the context of the present disclosure, fruits will be used as an example of the objects to describe how to identify the objects in the images. In other application contexts, videos can comprise other types of objects. For example, packages can be identified and tracked during logistics transportation in logistics management systems; and various vehicles can be identified and tracked in the road environment in traffic monitoring context, and so on.

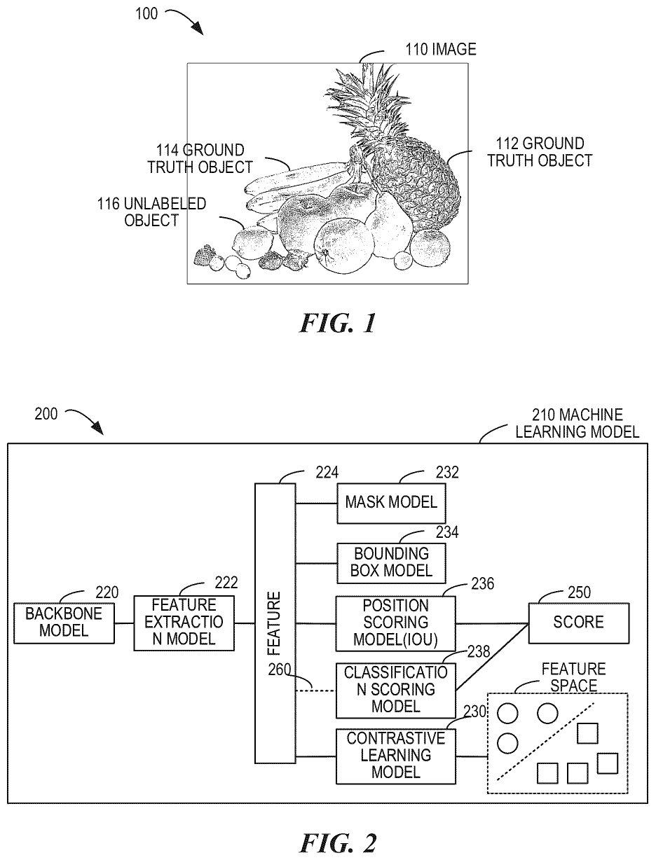

An overview for training a machine learning model is described with reference to FIG. 1, which shows a block diagram 100 of an image used as training data for a machine learning model in an implementation of the present disclosure. As shown in FIG. 1, the image 110 may be used as training data to train a machine learning model. Herein, it is desirable that the machine learning model may learn from the training data an association between the image and one or more objects in the image. In turn, an image to be processed may be input into the trained machine learning model so that the machine learning model may identify various objects from the image to be processed.

The machine learning model may be trained using an image 110, where the image 110 may comprise ground truth objects 112, . . . , and 114. Herein, the ground truth objects refer to labeled (e.g., manually and/or otherwise) objects in the image 110 in advance. During a training process, the machine learning model may continuously learn the association between the image and the one or more ground truth objects 112, . . . , and 114 in the image. It will be understood that although other objects (e.g., a lemon, an apple, a strawberry, etc.) are also comprised in the image 110, the other objects are not labeled. For example, the image 110 may further comprise an unlabeled object 116 (a lemon). Alternatively and/or additionally, the image 110 may comprise only two objects, i.e., a pineapple and a banana, and both objects are labeled as the ground truth objects.

It will be appreciated that although FIG. 1 only schematically illustrates a single image 110 used as the training data, a large number of training images may be obtained, and each training image may comprise a same or a different type of ground truth object. The training process may be performed iteratively with the large number of training images in order to obtain an optimized machine learning model.

However, due to the large number of fruits in the real world, it is difficult to provide training images that comprise all types of fruits, and it is difficult to label each type of fruit in the training images. This leads to the machine learning model can only learn knowledge about limited fruits (i.e., labeled fruits), and then when objects are identified from an image to be processed, only the fruits that have already been labeled in the training images can be identified. In other words, assuming that the labeled fruits in the training images only comprise pineapples and bananas, the machine learning model can only identify pineapples and bananas, but cannot identify lemons, and the machine learning model may improperly identify the lemons as background when an image comprising pineapples, bananas, and lemons is input to the machine learning model.

At this point, how to train the machine learning model in a more effective way and make the machine learning model identify objects that are not labeled in the training images to improve identification accuracy has become a difficult and hot spot in the field of image processing.

### Architecture of Object Identification Model

In order to at least partially address the deficiencies in prior art, a method for processing an image using a machine learning model is proposed according to an example implementation of the present disclosure. A summary of an example implementation according to the present disclosure is described with reference to FIG. 2, which shows a block diagram 200 of a structure of a machine learning model for identifying an object from an image according to some implementations of the present disclosure. As shown in FIG. 2, the machine learning model 210 may comprise a plurality of internal models. For example, a backbone model 220 may be implemented based on a plurality of network models currently known and/or to be developed in the future, and this backbone model 220 may perform processing on a received image, such as identifying respective candidate objects in the images based on a querier, so that a downstream feature extraction model 222 can extract feature(s) of respective candidate objects in the image. The feature extraction model 222 may describe an association between the image and a feature of at least one candidate object. In other words, the feature extraction model 222 may extract features 224 of respective candidate objects.

Further, the machine learning model 210 may comprise: a mask model 232 for describing an association between the feature of the at least one candidate object and a region of the at least one candidate object; a bounding box model 234 for describing an association between the feature of the at least one candidate object and a bounding box of the at least one candidate object in the image; a position scoring model 236 for describing an association between the feature of the at least one candidate object and a position score of the at least one candidate object, the position score representing a difference between a position of the at least one candidate object and a ground truth position of the at least one ground truth object; and a classification scoring model 238 for describing an association between the feature of the at least one candidate object and a classification score of the at least one candidate object, the classification score representing a probability that the at least one candidate object is classified as foreground in the image.

According to an example implementation of the present disclosure, the machine learning model 210 may further comprise a contrastive learning model 230. The contrastive learning model 230 herein may adjust a parameter of an upstream module based on contrastive learning, so that the feature extraction model 220 can pull closer the distance between a feature of a labeled object and a feature of a candidate object with the same type as the labeled object, and can push farther the distance between a feature of a labeled object and a feature of a candidate object with different types from the labeled object. According to an example implementation of the present disclosure, respective ones of the above modules in the machine learning model 210 can be trained separately and/or in combination, so that the machine learning model 210 can obtain an association between the image and the object.

### Model Training Process

According to an example implementation of the present disclosure, update parameters (e.g., an update gradient determined based on loss function) for respective models can be determined based on respective ground truth data of an image, in order to train respective models accordingly. For example, an update parameter associated with the classification scoring model may be determined based on a classification score of at least one candidate object in an image and a ground truth classification score of at least one ground truth object in the image. It will be understood that in general, an image may comprise foreground and background. For example, as shown in FIG. 1, in the image 110, various fruits belong to the foreground of image 110, and the white blank region belongs to the background of the image 110. Numerical values between [0, 1] can be used to represent a probability that a certain candidate object belongs to foreground.

A probability that a candidate object is labeled as foreground can be used as a classification score. At this point, a ground truth label of the image 110 can comprise a foreground region and a background region, and the classification score of the foreground region is 1 and the classification score of the background region is 0. During forward propagation, an update parameter associated with the classification scoring model 238 (referred to as a classification update parameter) can be determined based on a classification score of at least one candidate object and a ground truth classification score of at least one ground truth object in an image. Specifically, a feature 224 can be input into the classification scoring model 238 to predict a classification score of a candidate object. Subsequently, the predicted classification score can be compared with a ground truth score of a ground truth object (i.e., the classification score 0 or 1 in the ground truth label) to determine a loss function of the classification scoring model 238. Subsequently, an update gradient of the model can be determined with the aim that the loss function is minimized, thereby this gradient is used as the update parameter for updating the classification scoring model 238.

According to an example implementation of the present disclosure, the classification scoring model 238 may be updated based on the determined update parameter. However, as shown by a dashed line 260 in FIG. 2, the backpropagation of the update parameter may be intercepted, and the update gradient associated with the classification scoring model 238 may not be used in updating an upstream model (e.g., the backbone model 220, the feature extraction model 222). In other words, when updating the upstream model, the classification update parameter is prevented from being used.

With an example implementation of the present disclosure, the classification update parameter is the update parameter only used to update of the classification scoring model 238 and is not used to update the upstream model. In this way, on one hand, it can be ensured that the classification scoring model 238 can learn semantic knowledge related to ground truth foreground and ground truth background in the image 110; on the other hand, when the feature extraction model 222 is updated, the knowledge related to foreground and background is not considered, so that a generated feature 224 does not focus too much on the boundary between the foreground and background of the image. In this way, when the machine learning model 210 is used to process fruits comprising a new type of fruit (such as a lemon), the lemon would be identified as a new type of fruit that is not labeled in the training data, rather than being identified as the background region.

The process of training the classification scoring model 238 has been described, and more details about training other models will be provided below. According to an example implementation of the present disclosure, the mask model 232 can be updated based on information in the ground truth label of the image 110. The mask model 232 herein can describe an association between a feature of the at least one candidate object and a region where the at least one candidate object is located in the image 110. Specifically, based on a comparison of a ground truth mask and a predicted mask output by the mask model 232, a corresponding loss function can be determined, and then an update parameter (i.e., an update gradient) used to update the mask model 232 can be determined. For ease of description, the update parameter associated with the mask model 232 can be referred to as mask update parameters.

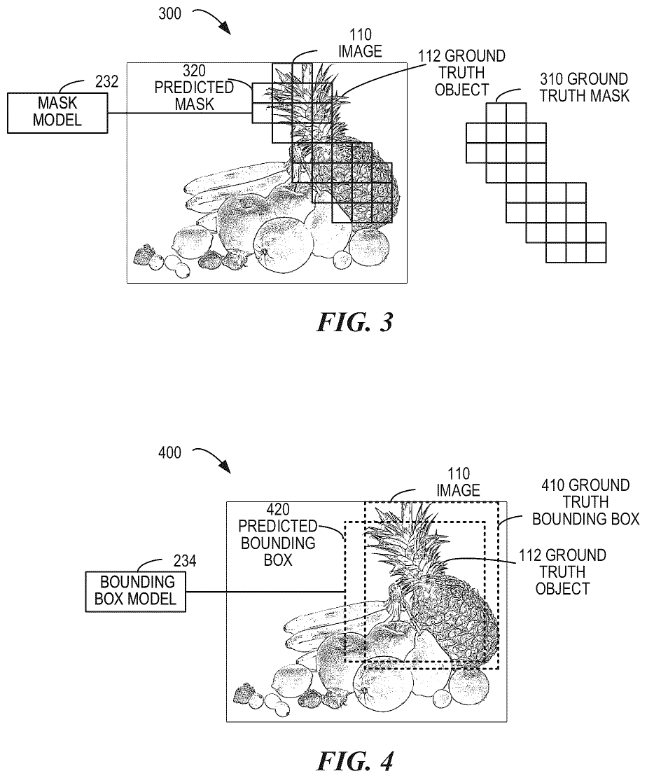

FIG. 3 illustrates a block diagram 300 of a process for determining an update parameter of a mask model according to some implementations of the present disclosure. As shown in FIG. 3, the ground truth label of the image 110 may comprise a ground truth object 112 and a corresponding ground truth mask 310 that may represent a pixel range of the ground truth object 112 in the image 110. It will be appreciated that the ground truth mask 310 in FIG. 3 is merely illustrative, and the ground truth mask 310 in the real environment may have higher accuracy. The feature 224 may be input into the mask model 232 during training, and the mask model 232 may output a predicted mask 320.

The predicted mask 320 can be compared with the ground truth mask 310 to determine the corresponding loss function and then determine the mask update parameter for updating the mask model 232. The mask model 232 can be updated with the mask update parameter. Further, since the quality of the feature 224 will affect the performance of the mask model 232, the mask update parameters can be considered during the process of updating the feature extraction model 222. In other words, the mask update parameter will be used to update the upstream model and the mask model 232. In this way, the parameter of the feature extraction model 222 is updated towards a direction that the generated feature helps to narrow the difference between the predicted mask 320 and the ground truth mask 310.

According to an example implementation of the present disclosure, the bounding box model 234 may be updated based on information in a ground truth label of the image 110. The bounding box model 234 herein may describe an association between the feature of the at least one candidate object and a bounding box of the at least one candidate object in the image. Specifically, based on a comparison of a ground truth bounding box and a predicted bounding box output by the bounding box model 234, a corresponding loss function can be determined, and then an update parameter (i.e., an update gradient) for updating the bounding box model 234 can be determined. For ease of description, the update parameter associated with the bounding box model 234 may be referred to as a bounding box update parameter.

FIG. 4 illustrates a block diagram 400 of a process for determining the update parameter for the bounding box model 234 according to some implementations of the present disclosure. As shown in FIG. 4, the ground truth label of the image 110 may comprise a ground truth object 112 and a corresponding ground truth bounding box 410, which may represent a rectangular range of the ground truth object 112 in the image 110. The feature 224 may be input into the bounding box model 234 during training, and the bounding box model 234 may output a predicted bounding box 420.

The predicted bounding box 420 can be compared with the ground truth bounding box 410 to determine the corresponding loss function and then determine the bounding box update parameter for updating the bounding box model 234. The bounding box update parameter can be used to update the bounding box model 234. Further, since the quality of the feature 224 will affect the performance of the bounding box model 234, the bounding box update parameter can be considered during the process of updating the feature extraction model 222. In other words, the bounding box update parameter will be used to update the upstream model and the bounding box model 234. In this way, the parameter of the feature extraction model 232 is updated towards a direction that the generated feature helps to narrow the difference between the predicted bounding box 420 and the ground truth bounding box 410.

According to an example implementation of the present disclosure, the position scoring model 236 can be updated based on position information of respective objects. The position scoring model 236 herein can describe an association between the feature of the at least one candidate object and a position score of the at least one candidate object. Specifically, a position of the at least one candidate object can be compared with a ground truth position of the at least one ground truth object, to determine a corresponding loss function and then determine an update parameter (i.e., an update gradient) for updating the position scoring model 236. For ease of description, the update parameter associated with the position scoring model 236 can be referred to as a position update parameter.

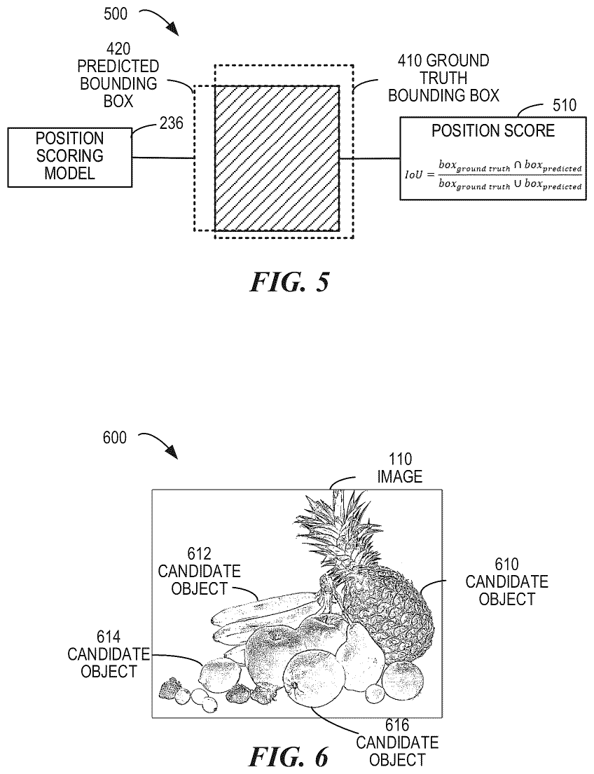

FIG. 5 shows a block diagram 500 of a process for determining an update parameter for a position scoring model according to some implementations of the present disclosure. As shown in FIG. 5, a position score for a candidate object may be determined using the Intersection of Union of the predicted bounding box 420 and the ground truth bounding box 410 based on the following Equation 1.

$$IoU = \frac{{box}_{ground truth} ⋂ {box}_{predicted}}{{box}_{ground truth} ⋃ {box}_{predicted}} \qquad Equation 1$$

In Equation 1, IoU represents the position score of the candidate object. box_{ground truth} represents the ground truth bounding box 410, and box_{predicted} represents the predicted bounding box 420. In this way, position scores of respective candidate objects can be determined by simple mathematical operations. It will be understood that the value of the IoU score ranges between 0 and 1, and the larger the value is, the more accurate the position is. When the predicted bounding box 420 is superposed with the ground truth bounding box 410, the IoU score is 1, which represents the highest accuracy of the position scoring model 236.

According to an example implementation of the present disclosure, each candidate object identified from the image 110 can be processed in a similar manner and a corresponding score can be determined. A corresponding loss function can be determined, and the position update parameter for updating the position scoring model 236 can be determined in turn. The position update parameter can be used to update the position scoring model 236. Further, since the quality of the feature 224 will affect the performance of the position scoring model 236, the position update parameter can be considered in the process of updating the feature extraction model 222. In other words, the position update parameter will be used to update the upstream model and the position scoring model 236. In this way, the parameter of the feature extraction model 232 can be updated with the aim that the generated feature is made more conducive to improving the position score (e.g., closer to 1).

According to an example implementation of the present disclosure, the machine learning model 210 further comprises the contrastive learning model 230. The contrastive learning model 230 can use contrastive learning principles and make a distribution of the feature 224 in feature space 240 consistent with a distribution of a feature of a labeled object. Specifically, it is expected that the update parameter generated by the contrastive learning model 230 can update the feature extraction model 222 towards a direction for pulling closer the distance between the feature of the labeled object and a feature of an object corresponding to that labeled object, and pushing farther the distance between the feature of the labeled object and a feature of an object not corresponding to that labeled object.

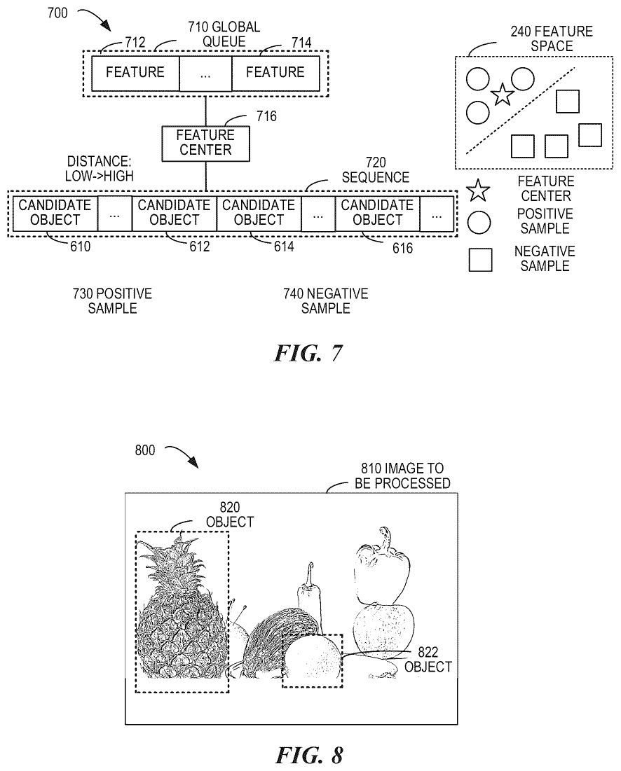

According to the contrastive learning principles, a positive sample and a negative sample for contrastive learning can be selected from the at least one candidate object. More details of selecting samples are described in FIG. 6, which shows a block diagram 600 of a plurality of candidate objects in an image according to some implementations of the present disclosure. As shown in FIG. 6, it is assumed that a plurality of candidate objects 610, 612, 614, . . . , and 616 are identified from the image 110. Respective candidate objects can be compared with the ground truth object in the ground truth label of image 110. Specifically, a global queue can be constructed to store a relevant feature of a candidate object corresponding to the ground truth object. More details on selecting a positive sample and a negative sample based on the global queue are described with a reference to FIG. 7. FIG. 7 shows a block diagram 700 of a process for selecting a positive sample and a negative sample from a plurality of candidate objects according to some implementations of the present disclosure.

Respective ground truth objects 112, . . . , 114 can be input to the feature extraction model 222 to determine corresponding ground truth features. The features of the respective candidate objects can be compared with those of the respective ground truth objects, to select a candidate object similar to a ground truth object from the respective candidate objects. At this point, the features of the candidate objects and the ground truth features of the ground truth objects are output by the feature extraction model 222. By comparing these two features, it can facilitate to select the positive sample and the negative sample for training the contrastive learning model. As shown in FIG. 7, features 712, . . . , 714 of the similar candidate objects corresponding to the ground truth objects 112, . . . , 114 respectively can be added to a global queue 710.

According to an example implementation of the present disclosure, a pooling operation may be performed on the global queue 710 to determine a feature center 716. In this way, the feature center 716 can reflect a distribution trend of the features of the ground truth objects in the feature space 240, which is more conducive to selecting the positive sample and the negative sample. For example, a candidate object with a smaller distance from the feature center 716 can be selected as the positive sample, and a candidate object with a larger distance from the feature center 716 can be selected as the negative sample. In this way, by using the selected positive and negative samples to perform the training process, the feature extraction model 222 can be updated with the aim that the degree to which the feature distinguishes objects is improved.

As shown in FIG. 7, a plurality of candidate objects 610, 612, 614, . . . , 616 . . . can be ranked in ascending order of distance to generate a sequence 720. At this time, features of candidate objects located at the head of the sequence 720 are closer to the feature center, so these candidate objects can be used as the positive sample. Features of candidate objects located at the ending of the sequence 720 are more distant from the feature center, so these candidate objects can be used as the negative sample.

According to an example implementation of the present disclosure, the positive and negative samples can be selected from both ends of the sequence 720, respectively. For example, a first number (e.g., a positive integer k1) of candidate objects with a smaller distance can be selected from the head position of the sequence 720 as the positive sample. As another example, the negative sample can be selected from a position after respective positive samples in the sequence 720. Specifically, a second number (e.g., a positive integer k2) of candidate objects with a larger distance can be selected from the ending position as the negative sample. At this point, the positive sample is simple positive sample that is easy to distinguish, and the negative sample is simple negative sample that is easy to distinguish. In this way, the respective models can be trained with the aim that the feature is made more conducive to distinguishing objects.

It will be understood that although the above sample selection method can make it easy for the models to distinguish different objects, there is a large difference between the positive and negative samples at this time, so the positive and negative samples are too simple for the model to distinguish the details between different objects. At this time, the second number of candidate objects can be selected from candidate objects adjacent to the first number of candidate objects in the sequence 720 as the negative sample.

As shown in FIG. 7, in the case where k1 candidate objects 610, . . . , 612 have been selected as a positive sample 730, k2 candidate objects 614, . . . , 616 adjacent to the positive sample 730 can be selected as a negative sample 740. Since the negative sample 740 are adjacent to the positive sample 730 immediately, there is a small distance between the negative sample 740 and the feature center 716 in comparison to the respective candidate objects located at the ending of the sequence 720. At this point, the negative sample 740 will participate in training as a “hard” negative sample. In this way, the models can learn more details for distinguishing various objects, such that the output feature 224 is more conducive to distinguishing various objects in an image.

In the following, the specific process for selecting a sample is described. The global queue 710 of length L can be maintained to store features of labeled ground truth objects in a training image. Specifically, after being processed by the feature extraction model 222, N objects comprised in an image can generate N features (with dimensions N*c, wherein c represents the dimensions of the features). One or more candidate objects that are closest to the ground truth objects can be selected from the above features, and features of the selected candidate objects can be added to the global queue 710. Furthermore, a pooling operation can be performed on the global queue 710 to obtain the feature center 716 (represented by a vector ν). Furthermore, selection of the positive and negative samples can be performed among the N candidate objects to complete contrastive learning in the feature space 240.

As shown on the right side of FIG. 7, in the feature space 240, a pentagram represents the feature center 716, a circle represents the positive sample 730, and a square represents the negative sample 740. At this point, the positive sample 730 is close to the feature center 716, and the negative sample 740 is far away from the feature center 716. In this way, the feature output by the feature extraction module can be more conducive to distinguishing between various objects.

According to an example implementation of the present disclosure, positive and negative samples can be selected based on an optimal transport algorithm. Specifically, a loss matrix C(N*M) between N predicted candidate objects and M labeled ground truth objects can be calculated, and a classification score and a position score both can be comprehensively considered to determine the loss. Specifically, the loss between the predicted candidate objects and the ground truth objects can be determined based on the following Equation 2.

C=λ_{cls}·C_{cls}+λ_{box}·C_{box} Equation 2

In Equation 2, C represents the loss. λ_{cls} and C_{cls} represent a weight and a loss related to the classification scoring model respectively. λ_{box} and C_{box} represent a weight and a loss related to the bounding box model respectively. Alternatively and/or additionally, C_{box} can be determined based on both a loss of a bounding box itself and an IoU-related loss. Respective candidate samples can be sorted based on the loss to form the sequence 720. Further, k1 candidate objects with the smallest loss can be selected from the sequence 720 as the positive sample, and k2 candidate objects after the positive sample can be selected as the negative sample. At this time, the k2 candidate objects can be used as a hard negative sample.

According to an example implementation of the present disclosure, after the k1 positive samples and the k2 negative samples have been determined, training may be performed using these samples, so that the feature extraction model 222 is updated with the aim that it is more conducive to distinguishing objects. Specifically, it is assumed that a sample space is represented with [symbol] , the features of the positive sample (object) are represented with [symbol] ⁺, and features of the negative sample (background) are represented with [symbol] ⁻. A contrastive loss may be determined based on the following Equation 2.

$${ℒ}_{con} = - log \frac{{\sum }_{{k}^{+} ∈ {𝒦}^{+}} exp ( υ \cdot {k}^{+} )}{{\sum }_{{k}^{+} ∈ {𝒦}^{+}} exp ( υ \cdot {k}^{+} ) + {\sum }_{{k}^{-} ∈ {𝒦}^{-}} exp ( υ \cdot {k}^{-} )} \qquad Equation 3$$

In Equation 3, [symbol] _{con} represents the contrastive loss. [symbol] represents the sample space. The features of the positive sample are represented with [symbol] ⁺. The features of the negative sample are represented with [symbol] ⁻, and ν represents the feature center. The update parameter (e.g., an update gradient) associated with the contrastive learning model 230 can be determined based on the contrastive loss defined in Equation 3. For ease of description, the update parameter associated with the contrastive learning model 230 can be referred to as a contrastive update gradient. Further, the feature extraction model 222 can be updated using the contrastive update gradient during training.

In this way, the features in the queue correspond to the labeled objects in the training data, which can easily distinguish labeled objects from unlabeled objects, thereby can improve the difference of the features. Furthermore, the position of the feature center in the feature space is stable, so the consistency of the features can be improved. In this way, the difference and consistency of the features output by the feature extraction model can be improved, which facilitates to improve the accuracy of the machine learning model in extracting objects from images.

According to an example implementation of the present disclosure, the image 110 used as the training data may comprise at least one labeled ground truth object, and the image 110 further comprises at least one unlabeled object. In other words, it is not possible for the training data to label all objects in the real world. In this case, using the example implementation of the present disclosure, by intercepting the update gradient generated by the loss function of the classification scoring model 238, the boundary between the foreground and background in the training image can be weakened, thereby the situation that machine learning model 210 erroneously identifies an object (such as a lemon) of unknown classification as background can be avoided.

Furthermore, the contrastive learning process described above enable the feature output by the feature extraction model 222 shorten the distance between a candidate object and a labeled object and lengthen the distance between a candidate object and an unlabeled object. In this way, the feature extraction model 222 can be updated with the aim that it is more conducive to improving the accuracy of object identification.

It will be understood that, although the process for training the feature extraction model 222 based on the loss functions of the respective models is described above, all and/or a part of the above-described process may be combined, in order to train the feature extraction model 222. Hereinafter, the process for determining an overall loss function based on the loss functions for a plurality of aspects will be described in a specific equation.

According to an example implementation of the present disclosure, the loss functions associated with the plurality of aspects described above (the mask model 232, the bounding box model 234, the position scoring model 236, the classification scoring model 238, the contrastive learning model 230) can be combined to determine the overall loss function during training. The overall loss function can be determined based on the following Equation 4:

[symbol]

=λ_{cls}· [symbol] _{cls}+λ_{box}· [symbol] _{box}+λₘₐₛₖλ [symbol] ₘₐₛₖ+λᵢₒᵤ· [symbol] ᵢₒᵤ+λ_{con}· [symbol] _{con} Equation 4

In Equation 4, [symbol] represents the overall loss function. λ_{cls} and C_{cls} represent a weight and a loss related to the classification scoring model 238 respectively. λ_{box} and C_{box} represent a weight and a loss related to the bounding box model 234 respectively. λₘₐₛₖ and Cₘₐₛₖ represent a weight and a loss related to the mask model 232 respectively. λ_{IoU} C_{IoU} represent a weight and a loss related to the position scoring model 236 respectively, λ_{con} and C_{con} represent a weight and a loss related to the contrastive learning model 230 respectively. In this way, when training the feature extraction model 222, various factors can be comprehensively considered, thereby making the feature 224 output by the feature extraction model 222 more suitable for object identification. In this way, the accuracy of object identification can be further improved.

It will be understood that the training process described above is only illustrative, and specific details of the training process can be modified based on the needs of specific application contexts. For example, the training process may comprise more, fewer, or different processes.

### Model Application Process

The training process for respective models in the machine learning model 210 has been described above. Hereinafter, how to use the machine learning model 210 to identify respective objects in an image to be processed will be described. According to an example implementation of the present disclosure, an image to be processed can be input to the machine learning model 210, and the machine learning model 210 can identify and output relevant information for respective objects at this point.

FIG. 8 shows a block diagram 800 of objects identified from an image to be processed using a machine learning model according to some implementations of the present disclosure. As shown in FIG. 8, a trained machine learning model 210 can be used to identify objects in an image to be processed 810. Specifically, the bounding box model 234 in the machine learning model 210 can be used to determine the bounding boxes of respective candidate objects in the image to be processed 810. In this way, positions of the respective identified objects can be clearly indicated, thereby improving the user's visual experience.

As shown in FIG. 8, objects 820 (a pineapple), . . . , and 822 (a lemon) can be identified. At this time, the object 820 is a ground truth object labeled in the image 110 used as training data (i.e., the fruit “pineapple” has been labeled in the training data), and the object 822 is an object not labeled in the image 110 used as the training data (i.e., the fruit “lemon” has not been labeled in the training data). With an example implementation of the present disclosure, machine learning model 210 can identify not only objects labeled in the training data, but also objects not labeled in the training data.

According to an example implementation of the present disclosure, scores of the identified candidate objects may be determined based on the respective models in the machine learning model 210. Specifically, the image to be processed 810 may be input to the machine learning model 210, and position scores of the respective candidate objects in the image to be processed 810 may be determined using the position score model 236. For example, the position scores of the object 820 and the object 830 may be 0.9 and 0.8 respectively. Further, the classification score model 238 may be used to determine classification scores of the respective candidate objects in the image to be processed 810. For example, the position scores of the object 820 and the object 830 may be 0.7 and 0.6 respectively. Further, final scores of the respective candidate objects in the image to be processed 810 may be determined based on the geometric mean of the position scores and the classification scores of the respective candidate objects.

According to an example implementation of the present disclosure, the final scores of the respective candidate objects can be determined based on the average of the position scores and the classification scores. In this case, the final score of the object 820 can be expressed as \sqrt{0.9*0.7}=0.794, and the final score of the object 822 can be expressed as \sqrt{0.8*0.6}=0.693. The final score herein can represent a probability that the identified object is an accurate object. Therefore, the above-mentioned final score can represent that the probability that the object 820 is an actual object in the image to be processed 810 is 80%, and the probability that the object 822 is an actual object in the image to be processed 810 is 70%. With an example implementation of the present disclosure, the factors of a position score and a classification score can be comprehensively considered, thereby improving the accuracy of determining a final score of an object.

It will be understood that in the above example, the image to be processed 810 comprises a plurality of objects. Although the object 822 is an object unlabeled in the training data (that is, at least one unlabeled object is not comprised in labeled ground truth objects in the image used to train the machine learning model), the machine learning model 210 can identify the object 822. In this way, the machine learning model trained based on the above method can provide more flexible object identification capabilities in an open world environment. At this point, a machine learning model with the ability to identify unlabeled objects can be obtained by merely providing training data in which a part of objects has been labeled.

According to an example implementation of the present disclosure, the mask model 232 in the machine recognition model 210 can determine regions of the respective candidate objects in the image to be processed 810. For example, mask regions can be overlapped on the image to be processed 810 to indicate pixel regions covered by the respective objects. In this way, the range of the respective objects can be represented more accurately, for example, green can be used to represent the range where the object 820 is located, and yellow can be used to represent the range where the object 822 is located.

The training process described above can be implemented on a plurality of public datasets, and the trained machine learning model can be used to perform image identification operations. The performance of the model can be evaluated using class-agnostic methods. Specifically, the performance of the model can be evaluated using the following two methods: Average Recall (AR) and mean Average Precision (mAP). Through experiments, it can be seen that on public datasets such as COCO, LVSI, UVO, and Objects365, the AR performance and mAP performance of the machine learning model obtained using the process described above are better than those of the currently known machine learning models.

It will be understood that although the specific process of object identification has only been described with fruits as examples of objects in images, in the context of the present disclosure, objects can comprise various tangible entities in the real world, comprising but not limited to people, animals, objects, and so on. Furthermore, although the object identification process has been described with identifying objects in a single image as an example, objects in a plurality of images can be identified. For example, objects in respective video frames in a video sequence can be identified. In the case of identifying objects in respective video frames, respective objects can be further tracked in video training.

### Example Process

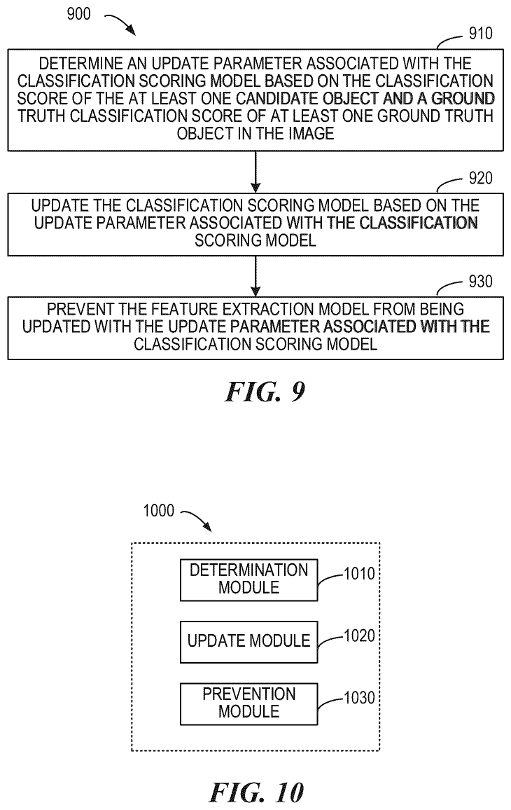

FIG. 9 illustrates a flowchart of a method 900 for processing an image using a machine learning model according to some implementations of the present disclosure. The machine learning model is used for identifying at least one candidate object from an image, and the machine learning model comprises: a feature extraction model for describing an association between the image and a feature of the at least one candidate object; and a classification scoring model for describing an association between the feature of the at least one candidate object and a classification score of the at least one candidate object. The classification score represents a probability that the at least one candidate object is classified as foreground in the image. Specifically, at block 910, an update parameter associated with the classification scoring model is determined based on the classification score of the at least one candidate object and a ground truth classification score of at least one ground truth object in the image. At block 920, the classification scoring model is updated based on the update parameter associated with the classification scoring model. At block 930, the feature extraction model is prevented from being updated with the update parameter associated with the classification scoring model.

According to an example implementation of the present disclosure, the machine learning model further comprises a position scoring model that describes an association between the feature of the at least one candidate object and a position score of the at least one candidate object, the position score representing a difference between a position of the at least one candidate object and a ground truth position of the at least one ground truth object, and the method 900 further comprises: determining an update parameter associated with the position scoring model based on the position of the at least one candidate object and the ground truth position of the at least one ground truth object; and updating the feature extraction model based on the update parameter associated with the position scoring model.

According to an example implementation of the present disclosure, the machine learning model further comprises a mask model that describes an association between the feature of the at least one candidate object and a region of the at least one candidate object, and the method 900 further comprises: determining an update parameter associated with the mask model based on the region of the at least one candidate object and a ground truth region of the at least one ground truth object; and updating the feature extraction model with the update parameter associated with the mask model.

According to an example implementation of the present disclosure, the machine learning model further comprises a bounding box model that describes an association between the feature of the at least one candidate object and a bounding box of the at least one candidate object in the image, and the method 900 further comprises: determining an update parameter associated with the bounding box model based on the bounding box of the at least one candidate object and a ground truth bounding box of the at least one ground truth object; and updating the feature extraction model based on the update parameter associated with the bounding box model.

According to an example implementation of the present disclosure, the machine learning model further comprises a contrastive learning model, and the method 900 further comprises: selecting, from the at least one candidate object, a positive sample and a negative sample for contrastive learning; determining, using the positive sample and the negative sample, an update parameter associated with the contrastive learning model; and updating the feature extraction model with the update parameter associated with the contrastive learning model.

According to an example implementation of the present disclosure, selecting the positive sample and the negative sample comprises: determining a sequence of the at least one candidate object based on a comparison between the at least one candidate object and the at least one ground truth object; and selecting, from the sequence, the positive sample and the negative samples.

According to an example implementation of the present disclosure, determining the sequence of the at least one candidate object comprises: selecting, from the at least one candidate object, a similar candidate object that is similar to the at least one ground truth object based on a comparison between the feature of the at least one candidate object and a ground truth feature of the at least one ground truth object; determining a feature center using the feature of the similar candidate object; and determining the sequence of the at least one candidate object based on a distance between the feature of the at least one candidate object and the feature center.

According to an example implementation of the present disclosure, determining the distance between the feature of the at least one candidate object and the feature center comprises: determining the distance based on an optimal transport strategy.

According to an example implementation of the present disclosure, selecting the positive sample from the sequence comprises: selecting a first number of candidate objects from an end of the sequence as the positive samples.

According to an example implementation of the present disclosure, selecting the negative sample from the sequence comprises: selecting a second number of candidate objects, from further candidate objects after the first number of candidate objects in the sequence, as the negative sample.

According to an example implementation of the present disclosure, selecting the second number of candidate objects as the negative sample comprises: selecting the second number of candidate objects, from candidate objects adjacent to the first number of candidate objects among the further candidate objects, as the negative sample.

According to an example implementation of the present disclosure, the image comprises at least one labeled ground truth object, and the image further comprises at least one unlabeled object.

According to an example implementation of the present disclosure, the method 900 further comprises: inputting an image to be processed to the machine learning model; determining, using the position scoring model, a position score of at least one candidate object in the image to be processed; determining, using the classification scoring model, a classification score of the at least one candidate object in the image to be processed; and determining, based on geometric mean of the position score and the classification score, a final score of the at least one candidate object in the image to be processed.

According to an example implementation of the present disclosure, the image to be processed comprises at least one unlabeled object, and the at least one unlabeled object is not comprised in labeled ground truth objects in an image used to train the machine learning model.

According to an example implementation of the present disclosure, the method 900 further comprises at least any of: determining, using the mask model, a region of at least one candidate object in the image to be processed; and determining, using the bounding box model, a bounding box of at least one candidate object in the image to be processed.

### Example Apparatuses and Devices

FIG. 10 shows a block diagram of an apparatus 1000 for processing an image using a machine learning model, according to some implementations of the present disclosure. The machine learning model is used for identifying at least one candidate object from an image, and the machine learning model comprises: a feature extraction model for describing an association between the image and a feature of the at least one candidate object; and a classification scoring model for describing an association between the feature of the at least one candidate object and a classification score of the at least one candidate object, the classification score representing a probability that the at least one candidate object is classified as foreground in the image.

The apparatus 1000 comprises: a determination module 1010 configured for determining an update parameter associated with the classification scoring model based on the classification score of the at least one candidate object and a ground truth classification score of at least one ground truth object in the image; an update module 1020 configured for updating the classification scoring model based on the update parameter associated with the classification scoring model; and a prevention module 1030 configured for preventing the feature extraction model from being updated with the update parameter associated with the classification scoring model.

According to an example implementation of the present disclosure, the machine learning model further comprises a position scoring model that describes an association between the feature of the at least one candidate object and a position score of the at least one candidate object, the position score representing a difference between a position of the at least one candidate object and a ground truth position of the at least one ground truth object , and the apparatus further comprises: a position score-based determination module configured for determining an update parameter associated with the position scoring model based on the position of the at least one candidate object and the ground truth position of the at least one ground truth object; and the update module 1020 is further configured for updating the feature extraction model based on the update parameter associated with the position scoring model.

According to an example implementation of the present disclosure, the machine learning model further comprises a mask model that describes an association between the feature of the at least one candidate object and a region of the at least one candidate object, and the apparatus further comprises: a mask-based determination module configured for determining an update parameter associated with the mask model based on the region of the at least one candidate object and a ground truth region of the at least one ground truth object; and the update module 1020 is further configured for updating the feature extraction model with the update parameter associated with the mask model.

According to an example implementation of the present disclosure, the machine learning model further comprises a bounding box model that describes an association between the feature of the at least one candidate object and a bounding box of the at least one candidate object in the image, and the apparatus further comprises: a bounding box-based determination module configured for determining an update parameter associated with the bounding box model based on the bounding box of the at least one candidate object and a ground truth bounding box of the at least one ground truth object; and the update module 1020 further be configured for updating the feature extraction model based on the update parameter associated with the bounding box model.

According to an example implementation of the present disclosure, the machine learning model further comprises a contrastive learning model, and the apparatus further comprises: a selection module configured for selecting, from the at least one candidate object, a positive sample and a negative sample for contrastive learning; a contrastive learning-based determination module configured for determining, using the positive sample and the negative sample, an update parameter associated with the contrastive learning model; and the update module 1020 is further configured for updating the feature extraction model with the update parameter associated with the contrastive learning model.

According to an example implementation of the present disclosure, the selection module comprises: a sequence determination module configured for determining a sequence of the at least one candidate object based on a comparison between the at least one candidate object and the at least one ground truth object; and a sample selection module configured for selecting, from the sequence, the positive sample and the negative sample.

According to an example implementation of the present disclosure, the sequence determination module comprises: a similar object selection module configured for selecting, from the at least one candidate object, a similar candidate object that is similar to the at least one ground truth object based on a comparison between the feature of the at least one candidate object and a ground truth feature of the at least one ground truth object; a center determination module configured for determining a feature center using the feature of the similar candidate object; and a sorting module configured for determining the sequence of the at least one candidate object based on a distance between the feature of the at least one candidate object and the feature center.

According to an example implementation of the present disclosure, the sorting module is further configured for determining the distance based on an optimal transport strategy.

According to an example implementation of the present disclosure, the sample selection module comprises selecting a first number of candidate objects from an end of the sequence as the positive samples.

According to an example implementation of the present disclosure, the sample selection module comprises selecting a second number of candidate objects, from further candidate objects after the first number of candidate objects in the sequence, as the negative sample e.

According to an example implementation of the present disclosure, the sample selection module comprises selecting the second number of candidate objects, from candidate objects adjacent to the first number of candidate objects among the further candidate objects, as the negative sample.

According to an example implementation of the present disclosure, the image comprises at least one labeled ground truth object, and the image further comprises at least one unlabeled object.

According to an example implementation of the present disclosure, the apparatus further comprises: an input module configured for inputting an image to be processed to the machine learning model; a position score determination module configured for determining, using the position scoring model, a position score of at least one candidate object in the image to be processed; a classification score determination module configured for determining, using the classification scoring model, a classification score of the at least one candidate object in the image to be processed; and a final score determination module configured for determining, based on geometric mean of the position score and the classification score, a final score of the at least one candidate object in the image to be processed.

According to an example implementation of the present disclosure, the image to be processed comprises at least one unlabeled object, and the at least one unlabeled object is not comprised in labeled ground truth objects in an image used to train the machine learning model.

According to an example implementation of the present disclosure, the apparatus further comprises at least any of: a mask determination module configured for determining, using the mask model, a region of at least one candidate object in the image to be processed; and a bounding box determination module configured for determining, using the bounding box model, a bounding box of at least one candidate object in the image to be processed.

FIG. 12 shows a block diagram of a device 1200 that can implement a plurality of implementations of the present disclosure. It should be understood that the computing device 1200 shown in FIG. 12 is merely exemplary and should not constitute any limitation on the functionality and scope of the implementations described herein. The computing device 1200 shown in FIG. 12 can be used to implement the method 600 shown in FIG. 6.

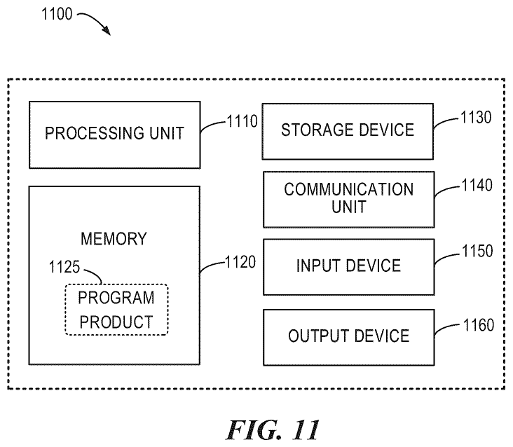

As shown in FIG. 11, computing device 1100 is in the form of a general purpose computing device. Components of the computing device 1100 may comprise, but are not limited to, one or more processors or processing units 1110, memory 1120, storage device 1130, one or more communication units 1140, one or more input devices 1150, and one or more output devices 1160. The processing unit 1110 may be an actual or virtual processor and is capable of performing various processes based on programs stored in memory 1120. In a multiprocessor system, a plurality of processing units execute computer executable instructions in parallel to improve the parallel processing capability of the computing device 1100.

Computing device 1100 typically comprises a plurality of computer storage media. Such media can be any available media accessible to computing device 1100, comprising but not limited to volatile and non-volatile media, removable and non-removable media. Memory 1120 can be volatile memory (such as registers, caches, random access memory (RAM)), non-volatile memory (such as read-only memory (ROM), electrically erasable programmable read-only memory (EEPROM), flash memory), or some combination thereof. Storage device 1130 can be removable or non-removable media, and can comprise machine-readable media such as flash drives, disks, or any other media that can be used to store information and/or data (such as training data for training) and can be accessed within computing device 1100.

The computing device 1100 may further comprise additional removable/non-removable, volatile/non-volatile storage media. Although not shown in FIG. 11, disk drives for reading or writing from removable, non-volatile disks (e.g., “floppy disks”) and optical disk drives for reading or writing from removable, non-volatile optical disks may be provided. In these cases, each drive may be connected to a bus (not shown) by one or more data media interfaces. Memory 1120 may comprise a computer program product 1125 having one or more program modules configured to perform various methods or actions of various implementations of the present disclosure.

The communication unit 1140 implements communication with other computing devices through a communication medium. Additionally, the functions of the components of the computing device 1100 can be implemented in a single computing cluster or a plurality of computing machines that can communicate through communication connections. Thus, the computing device 1100 can operate in a networked environment using logical connections with one or more other servers, network personal computers (PCs), or another network node.

The input device 1150 may be one or more input devices, such as a mouse, keyboard, trackball, etc. The output device 1160 may be one or more output devices, such as a display, speaker, printer, etc. The computing device 1100 may also communicate, as desired, via the communication unit 1140, with one or more external devices (not shown), such as storage devices, display devices, etc., with one or more devices that enable a user to interact with the computing device 1100, or with any device (e.g., network interface card, modem, etc.) that enables the computing device 1100 to communicate with one or more other computing devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the methods described above. According to example implementations of the present disclosure, there is also provided a computer program product that is tangibly stored on a non-transitory computer-readable medium and comprises computer-executable instructions that are executed by a processor to implement the methods described above. According to example implementations of the present disclosure, there is provided a computer program product having a computer program stored thereon that, when executed by a processor, implements the methods described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams and combinations of the blocks in the flowcharts and/or block diagrams can be implemented by computer-readable program instructions.

These computer-readable program instructions may be provided to a processing unit of a general purpose computer, special purpose computer, or other programmable data processing device to produce a machine that, when executed by a processing unit of a computer or other programmable data processing device, produces an apparatus that implements the functions/actions specified in one or more blocks in the flowchart and/or block diagrams. These computer-readable program instructions may also be stored in a computer-readable storage medium, which causes the computer, programmable data processing device, and/or other device to operate in a specific manner. Thus, the computer-readable medium storing the instructions comprises an article of manufacture that comprises instructions for implementing various aspects of the functions/actions specified in one or more blocks in the flowchart and/or block diagrams.

Computer-readable program instructions can be loaded onto a computer, other programmable data processing device, or other device to perform a series of operational steps on the computer, other programmable data processing device, or other device to produce a computer-implemented process, so that the instructions executed on the computer, other programmable data processing device, or other device implement the functions/actions specified in one or more blocks in the flowchart and/or block diagram.

The flowcharts and block diagrams in the accompanying drawings show the architecture, functions, and operations of possible implementations of systems, methods, and computer program products according to the present disclosure. In this regard, each block in the flowcharts or block diagrams may represent a module, program segment, or part of an instruction that contains one or more executable instructions for implementing a specified logical function. In some alternative implementations, the functions marked in the blocks may also occur in a different order than those marked in the drawings. For example, two consecutive blocks can actually be executed in substantially parallel, and they can sometimes be executed in the opposite order, depending on the functions involved. It should also be noted that each block in the diagrams and/or flowcharts, as well as combinations of blocks in the diagrams and/or flowcharts, can be implemented using a dedicated hardware-based system that performs the specified functions or actions, or can be implemented using a combination of dedicated hardware and computer instructions.

The above has described the various implementations of the present disclosure. The above description is exemplary, not exhaustive, and is not limited to the various implementations disclosed. Without departing from the scope and spirit of the various implementations described, many modifications and changes are obvious to those skilled in the art. The choice of terms used herein is intended to best explain the principles, practical applications, or improvements to the technology in the market, or to enable other skilled in the art to understand the various implementations disclosed herein.

I/we claim:

1. A method for processing an image using a machine learning model, the machine learning model being used for identifying at least one candidate object from an image, and the machine learning model comprising: a feature extraction model for describing an association between the image and a feature of the at least one candidate object; and a classification scoring model for describing an association between the feature of the at least one candidate object and a classification score of the at least one candidate object, the classification score representing a probability that the at least one candidate object is classified as foreground in the image, the method comprising:
determining an update parameter associated with the classification scoring model based on the classification score of the at least one candidate object and a ground truth classification score of at least one ground truth object in the image;
updating the classification scoring model based on the update parameter associated with the classification scoring model; and
preventing the feature extraction model from being updated with the update parameter associated with the classification scoring model.

2. The method of claim 1, wherein the machine learning model further comprises a position scoring model that describes an association between the feature of the at least one candidate object and a position score of the at least one candidate object, the position score representing a difference between a position of the at least one candidate object and a ground truth position of the at least one ground truth object, and the method further comprises:
determining an update parameter associated with the position scoring model based on the position of the at least one candidate object and the ground truth position of the at least one ground truth object; and
updating the feature extraction model based on the update parameter associated with the position scoring model.

3. The method of claim 2, wherein the machine learning model further comprises a mask model that describes an association between the feature of the at least one candidate object and a region of the at least one candidate object, and the method further comprises:
determining an update parameter associated with the mask model based on the region of the at least one candidate object and a ground truth region of the at least one ground truth object; and
updating the feature extraction model with the update parameter associated with the mask model.

4. The method of claim 3, wherein the machine learning model further comprises a bounding box model that describes an association between the feature of the at least one candidate object and a bounding box of the at least one candidate object in the image, and the method further comprises:
determining an update parameter associated with the bounding box model based on the bounding box of the at least one candidate object and a ground truth bounding box of the at least one ground truth object; and
updating the feature extraction model based on the update parameter associated with the bounding box model.

5. The method of claim 4, wherein the machine learning model further comprises a contrastive learning model, and the method further comprises:
selecting, from the at least one candidate object, a positive sample and a negative sample for contrastive learning;
determining, using the positive sample and the negative sample, an update parameter associated with the contrastive learning model; and
updating the feature extraction model with the update parameter associated with the contrastive learning model.

6. The method of claim 5, wherein selecting the positive sample and the negative sample comprises:
determining a sequence of the at least one candidate object based on a comparison between the at least one candidate object and the at least one ground truth object; and
selecting, from the sequence, the positive sample and the negative sample.

7. The method of claim 6, wherein determining the sequence of the at least one candidate object comprises:
selecting, from the at least one candidate object, a similar candidate object that is similar to the at least one ground truth object based on a comparison between the feature of the at least one candidate object and a ground truth feature of the at least one ground truth object;
determining a feature center using the feature of the similar candidate object; and
determining the sequence of the at least one candidate object based on a distance between the feature of the at least one candidate object and the feature center.

8. The method of claim 7, wherein determining the distance between the feature of the at least one candidate object and the feature center comprises: determining the distance based on an optimal transport strategy.

9. The method of claim 6, wherein selecting the positive sample from the sequence comprises: selecting a first number of candidate objects from an end of the sequence as the positive samples.

10. The method of claim 9, wherein selecting the negative sample from the sequence comprises: selecting a second number of candidate objects, from further candidate objects after the first number of candidate objects in the sequence, as the negative sample.

11. The method of claim 10, wherein selecting the second number of candidate objects as the negative sample comprises: selecting the second number of candidate objects, from candidate objects adjacent to the first number of candidate objects among the further candidate objects, as the negative sample.

12. The method of claim 1, wherein the image comprises at least one labeled ground truth object, and the image further comprises at least one unlabeled object.

13. The method of claim 12, further comprising:
inputting an image to be processed to the machine learning model;
determining, using the position scoring model, a position score of at least one candidate object in the image to be processed;
determining, using the classification scoring model, a classification score of the at least one candidate object in the image to be processed; and
determining, based on geometric mean of the position score and the classification score, a final score of the at least one candidate object in the image to be processed.

14. The method of claim 13, wherein the image to be processed comprises at least one unlabeled object, and the at least one unlabeled object is not comprised in labeled ground truth objects in an image used to train the machine learning model.

15. The method of claim 13, further comprising at least any of:
determining, using the mask model, a region of at least one candidate object in the image to be processed; and
determining, using the bounding box model, a bounding box of at least one candidate object in the image to be processed.

16. An electronic device comprising:
at least one processing unit; and
at least one memory coupled to the at least one processing unit and storing instructions for execution by the at least one processing unit which, when executed by the at least one processing unit, cause the electronic device to perform a method for processing an image using a machine learning model, the machine learning model being used for identifying at least one candidate object from an image, and the machine learning model comprising: a feature extraction model for describing an association between the image and a feature of the at least one candidate object; and a classification scoring model for describing an association between the feature of the at least one candidate object and a classification score of the at least one candidate object, the classification score representing a probability that the at least one candidate object is classified as foreground in the image, the method comprising:
determining an update parameter associated with the classification scoring model based on the classification score of the at least one candidate object and a ground truth classification score of at least one ground truth object in the image;
updating the classification scoring model based on the update parameter associated with the classification scoring model; and
preventing the feature extraction model from being updated with the update parameter associated with the classification scoring model.

17. The device of claim 16, wherein the machine learning model further comprises a position scoring model that describes an association between the feature of the at least one candidate object and a position score of the at least one candidate object, the position score representing a difference between a position of the at least one candidate object and a ground truth position of the at least one ground truth object, and the method further comprises:
determining an update parameter associated with the position scoring model based on the position of the at least one candidate object and the ground truth position of the at least one ground truth object; and
updating the feature extraction model based on the update parameter associated with the position scoring model.

18. The device of claim 17, wherein the machine learning model further comprises a mask model that describes an association between the feature of the at least one candidate object and a region of the at least one candidate object, and the method further comprises:
determining an update parameter associated with the mask model based on the region of the at least one candidate object and a ground truth region of the at least one ground truth object; and
updating the feature extraction model with the update parameter associated with the mask model.

19. The device of claim 18, wherein the machine learning model further comprises a bounding box model that describes an association between the feature of the at least one candidate object and a bounding box of the at least one candidate object in the image, and the method further comprises:
determining an update parameter associated with the bounding box model based on the bounding box of the at least one candidate object and a ground truth bounding box of the at least one ground truth object; and
updating the feature extraction model based on the update parameter associated with the bounding box model.

20. A computer readable storage medium having a computer program stored thereon which, when executed by a processor, causes the processor to perform a method for processing an image using a machine learning model, the machine learning model being used for identifying at least one candidate object from an image, and the machine learning model comprising: a feature extraction model for describing an association between the image and a feature of the at least one candidate object; and a classification scoring model for describing an association between the feature of the at least one candidate object and a classification score of the at least one candidate object, the classification score representing a probability that the at least one candidate object is classified as foreground in the image, the method comprising:
determining an update parameter associated with the classification scoring model based on the classification score of the at least one candidate object and a ground truth classification score of at least one ground truth object in the image;
updating the classification scoring model based on the update parameter associated with the classification scoring model; and
preventing the feature extraction model from being updated with the update parameter associated with the classification scoring model.
